(19) United States
(12) Patent Application Publication
(10) Pub. No.: US 2007/0076539 A1
(43) Pub. Date: Apr. 5, 2007

(54) Pickup unit and disk drive unit provided with such a pickup unit

(75) Inventors: Henricus Renatus Martinus Verberne, Eindhoven (NL); Ivon Franciscus Helwegen, Eindhoven (NL); Mohammed Meftah, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., BA Eindhoven (NL)

(21) Appl. No.: 10/579,872

(22) PCT Filed: Nov. 8, 2004
(86) PCT No.: PCT/IB04/52329

§ 371 Date: May 18, 2006

(30) Foreign Application Priority Data
Nov. 21, 2003 (EP) 03104299.7

(51) Int. Cl. G11B 7/00

(52) U.S. Cl. 369/44.16

(57) ABSTRACT

The invention relates to a pickup unit (1) for reading and/or writing data on a disk (2). The pickup unit comprises a base (5), a lens (3) in a lens holder (4) which is suspended from the base (5) and which is movable in at least a focusing direction of the lens (3), a pullback arrangement (9), and/or a locking arrangement (12, 12′). The pullback arrangement (9) and the locking arrangement (12, 12′) are adapted to act on the lens holder in order to prevent collisions between the lens (holder) and the disk, the pullback arrangement (9) is adapted to pull the lens holder (4) into an inoperative position remote from the disk, while the locking arrangement (12, 12′) is adapted to subsequently lock the lens holder in the inoperative position. In this manner collisions due to strong external mechanical forces or pulses exerted on the pick up unit can be effectively prevented.

### FIELD OF THE INVENTION

The invention relates to a pickup unit for reading and/or writing data on a disk.

### BACKGROUND OF THE INVENTION

Pickup units of this type are known in many embodiments and generally comprise a lens in a lens holder, a base, and a suspension for suspending the lens holder from the base, which suspension enables the lens holder to be moved with respect to the base at least in a focusing direction of the lens under the action of a focusing actuator. In order to read and/or write the data on the disk, the lens is moved along the surface of the disk while the disk is rotated. The development of disks having an increased data capacity, such as DVD, renders it more and more necessary to have a very small operating distance between the lens and the surface of the disk, smaller than the stroke of the lens holder with respect to the base, for example. The small operating distance leads to a risk of undesired collision between the lens(holder) and the disk, in particular when strong external mechanical forces or pulses are exerted on the pickup unit, for example by shaking or dropping a disk drive unit in which the pickup unit is provided. Collisions between the disk and the lens(holder) may lead to serious damage to the surface of the disk and therefore needs to be avoided. In the art, various pickup units are known wherein the risk of collisions between the lens(holder) and the disk is reduced by keeping the lens(holder) as much as possible in an inoperative position as far as possible away from the disk, as seen in the focusing direction of the lens.

US 2002/0075773 discloses a pickup unit of the type described above, wherein the lens holder is provided with a parking brake. This parking brake comprises two elastically deformable clamps forming a pair of tongs which are adapted to be clamped to a ramp provided at the base of the pickup unit. The clamps and the ramp are positioned such that they only engage in an inoperative position of the lens holder. In this manner the lens holder can be locked in the inoperative position when no data is read and/or written. When clamped to the ramp, the clamps are pushed over a wedge-shaped top section of the ramp and are subsequently fitted on a neck section in the middle of the ramp, such that the clamps bend in a direction perpendicular to the focusing direction of the lens. However, as the force to engage and disengage the clamps is delivered by the focusing actuator, which actuator is only adapted to deliver relatively weak actuating forces, the parking force delivered by the parking brake is limited too, so that a risk of disengagement exists when strong external mechanical forces or pulses are applied to the pickup unit.

JP 2002-251758 also discloses a pickup unit as described in the introduction, wherein the lens holder is further provided with a magnetic substance which can be attracted by an electromagnet mounted to the base. In this manner the lens holder can be parked in its inoperative position after being moved thereto by the focusing actuator. However, the relatively heavy magnetic substance seriously deteriorates the dynamic properties of the suspended lens holder.

### SUMMARY OF THE INVENTION

It is an object of the invention to provide a pickup unit for reading and/or writing data on a disk having improved properties with respect to the prevention of collisions between the lens(holder) and the disk when exposed to strong external mechanical forces or pulses.

According to a first aspect of the invention, the pickup unit according to the invention comprises the features of claim 1.

In the pickup unit according to claim 1, the lens holder is pulled into its inoperative position by means of the pullback arrangement driven by a dedicated pullback actuator acting from the base of the pickup unit. In this manner the pullback actuator may advantageously be dimensioned such that it is powerful and quick enough to pull the lens holder into its inoperative position even when strong external mechanical forces or pulses are exerted on the pickup unit. This feature is especially useful in preventing collisions between the lens holder and the disk during reading and/or writing of data on the disk.

According to a second aspect of the invention, the pickup unit according to the invention comprises the features of claim 9.

In the pickup unit according to claim 9, the lens holder is locked in its inoperative position by means of the locking assembly driven by a dedicated locking actuator. In this manner the lens holder is strongly fixed to the base when it is in its inoperative position, so that strong external mechanical forces or pulses exerted on the pickup unit cannot cause the lens holder to leave its inoperative position. This feature is especially useful in preventing collisions between the lens holder and the disk when no data is being read and/or written on the disk, for example between two reading and/or writing bursts or when the pickup unit has been switched off.

Thanks to the features as defined in claim 2 or 10, the mass and therefore the dynamic properties of the suspended lens holder are hardly affected by the presence of the engagement surface, as this surface may simply be formed by means of a slot or recess in the lens holder.

The invention also relates to a disk drive provided with a pickup unit according to the invention.

These and other aspects and advantages of the invention will be apparent from the following description, which is given with reference to the drawings.

### BRIEF DESCRIPTION OF THE DRAWINGS

FIG. 1 is a sectional side view schematically showing a first preferred embodiment of the disk drive according to the invention.

FIG. 2 is a sectional side view schematically showing a second preferred embodiment of the disk drive according to the invention.

In the drawings, the corresponding parts of the two preferred embodiments shown in the Figures are provided with the same reference numbers.

### DESCRIPTION OF THE PRESENTLY PREFERRED EMBODIMENTS

The drawings show embodiments of the pickup unit according to the invention. The pickup units 1 may be used in a device for reading and/or writing data on a disk 2, such as a compact disk player, which is adapted to read and/or write compact disks for audio and/or video by means of an optical and/or magnetic reading and/or writing member. The disk is rotatable about a rotation axis by means of an electrical drive unit-not shown in the drawings.

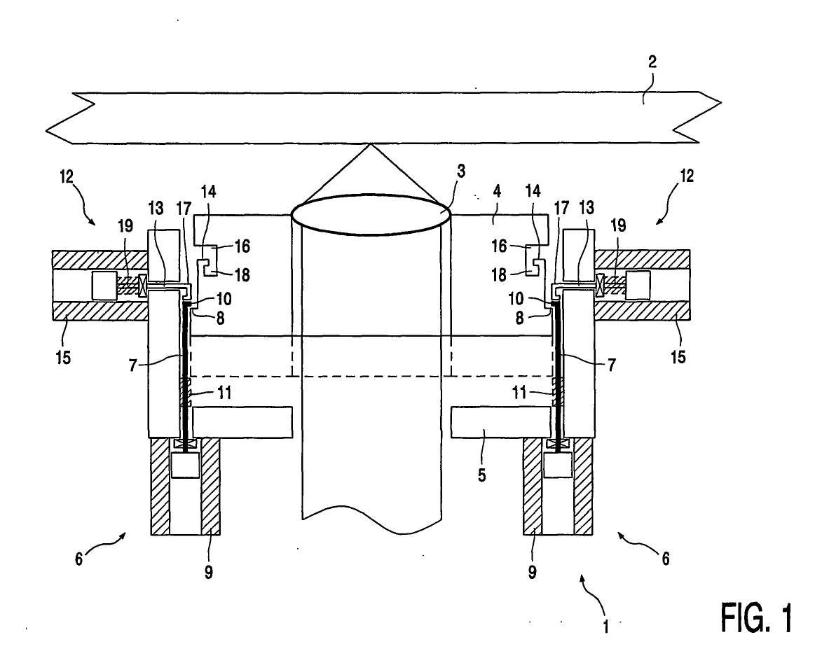

Data is encoded in one or more layers of the disk 2 for use in the above disk drive unit Various principles are known, each variant being suitable for use in conjunction with the invention. The data is laid down in one or more data tracks in digital form. The variations of (optical) properties along the data tracks contain the data recorded on the disk 2. To read and/or write the data on the disk 2, the disk 2 is rotated by means of a disk drive motor (not shown). The disk 2 is read and/or written by detection of the variations of (optical) properties along the data tracks by the pickup unit 1. In the embodiment shown in FIG. 1, the variations are detected by means of laser light emitted from and reflected back to the pickup unit 1.

With reference to FIG. 1, the first embodiment of the pickup unit 1 comprises a lens 3 mounted to a lens holder 4, which lens holder 4 is positioned within a base 5 of the pickup unit 1. The lens holder 4 is suspended from the base 5 by means of an elastic suspension (known in the art), which enables the lens holder 4 to be slightly moved with respect to the base 5 at least in a focusing direction of the lens 3. The lens holder 4 is moved with respect to the base 5 under the action of a focusing actuator (not shown) acting between the lens holder 4 and the base 5. When no forces are exerted on the lens holder 4, the lens holder 4 is in a steady position as shown in FIG. 1. The focusing actuator may comprise a plurality of permanent magnets connected to the base and a plurality of coils provided at the lens holder 4, such that the coils and the permanent magnets can exert forces on the lens holder 4 by means of electric currents through the coils. The movement of the lens holder 4 with respect to the base 5 and the disk 2 is used to focus the laser light to an exact point on the data track in the disk 2. The distance between the lens 3 and the disk 2 is typically 150 μm (for example when blue-ray laser light is used), while the stroke of the suspended lens holder 4 is typically 1 to 2 mm. It will therefore be appreciated that external mechanical forces or pulses exerted on the pickup unit 1, for example caused by a shock, may lead to undesired collisions between the lens(holder) 3,4 and the disk 2.

With reference to FIG. 1, the first embodiment of the pickup unit 1 is provided with a pullback arrangement 6 which is adapted to pull the lens holder 4 into an inoperative position. In its inoperative position, the lens holder 4 is located at a safe distance from the disk 2, whereby collisions between the lens (holder) 4 and the lens 3 are effectively prevented. In the drawing, the inoperative position is indicated by dashed lines. The pullback arrangement 6 comprises two first pullback members 7 having an elongated shape, for example wire members, two second engagement members 8 each in the form of an engagement surface on the lens holder, and two solenoids as pullback actuators 9. The first and second engagement members 7,8 and the pullback actuators 9 are positioned on opposite sides of the lens holder 4. As shown in FIG. 1, each first pullback member 7 is provided with a hook section 10 at one end. The first pullback members 7 are movable through the base 5 in a direction substantially parallel to the focusing direction of the lens 3, with the hook sections 10 facing the lens holder 4. Each first pullback member 7 is connected to one of the two pullback actuators 9, and the pullback actuators 9 are mounted to the base 5. In this manner the pullback actuators 9 are adapted to move the first pullback members 7 when they are provided with an activating signal, such as an electrical current.

With reference to FIG. 1, the engagement surfaces forming the second engagement members 8 are formed on the lens holder 4 in a direction substantially perpendicular to the focusing direction of the lens 3. The engagement surfaces forming the second engagement members 8 and the hook sections 10 of the first pullback members 7 are positioned such that they automatically engage during the movement of the first pullback members 7 towards the base.

With reference to FIG. 1, the first pullback members 7 and the pullback actuators 9 are dimensioned such that their stroke is sufficient to pull the lens holder 4 into its inoperative position as indicated by the dashed lines. In order to return the first pullback members 7 to their disengaged position, the first pullback members 7 are each provided with a return member 11, such as a spring, acting between the pullback members 7 and the base 5. In this manner the pullback actuators 9 only need to be activated when the lens holder 4 is to be pulled into its inoperative position. As the dedicated pullback actuators 9 act from the base 5 of the pickup unit 1, they can be dimensioned such that they are powerful enough to overcome the external forces or pulses that may act on the lens holder 1, and such that they are quick enough to pull the lens holder 4 away from the disk 2 in order to effectively prevent collisions with the disk 2.

With reference to FIG. 1, the first embodiment of the pickup unit is provided with a locking arrangement 12 comprising two first locking members 13 having an elongated shape, for example wire members, two second locking members 14 each in the form of a locking surface of the lens holder 4, and two solenoids as locking actuators 15. The first and second locking members 13, 14 and the locking actuators 15 are positioned on opposite sides of the lens holder 4. The first locking members 13 are movable through the base 5 in a direction substantially perpendicular to the focusing direction of the lens 3. Each first locking member 13 is connected to one of the two locking actuators 15, and the locking actuators 15 are mounted to the base 5. In this manner the locking actuators 15 are adapted to move the first locking members 13 towards the lens holder 4 when they are provided with an activating signal in the form of an electrical current

With reference to FIG. 1, the locking surfaces forming the second locking members 14 are formed by recesses 16 in the lens holder 4, while the locking surfaces forming the second locking members 14 extend at least partly in a direction substantially perpendicular to the focusing direction of the lens 3. Each first locking member 13 and each locking surface forming the second locking member 14 is positioned such that they are in engagement with each other when the first locking members 13 have been moved in the lens holder 4 and the lens holder 4 is in its inoperative position as indicated with the dashed lines in the drawing.

As shown in FIG. 1, the first locking members 13 are each provided with a U-shaped hook section 17 at one end, with the hook section 17 of each first locking member 13 facing the lens holder 4. Each of the recesses in the lens holder 4 forming the second locking members 14 is further provided with a hook-shaped securing section 18. The securing sections 18 are adapted to coincide with the hook sections 17 of the first locking members 13 when they are in engagement with the recesses forming the second locking members 14, so that the hook sections 17 and the securing sections 18 form securing members adapted to secure the engagement of the first and second locking members 13, 14. The locking arrangement 12 may be provided with return members 19, such as springs, in order to pull the first locking members 13 in the direction of the locking actuators 15. In this manner the locking actuators 15 only need to be powered when the first locking members 13 are to be brought into engagement with the second locking members 14, while the U-shaped hook sections 17 of the first locking members 13 and the hook-shaped securing sections 18 of the recesses are kept in engagement by the return forces exerted by the return members 19.

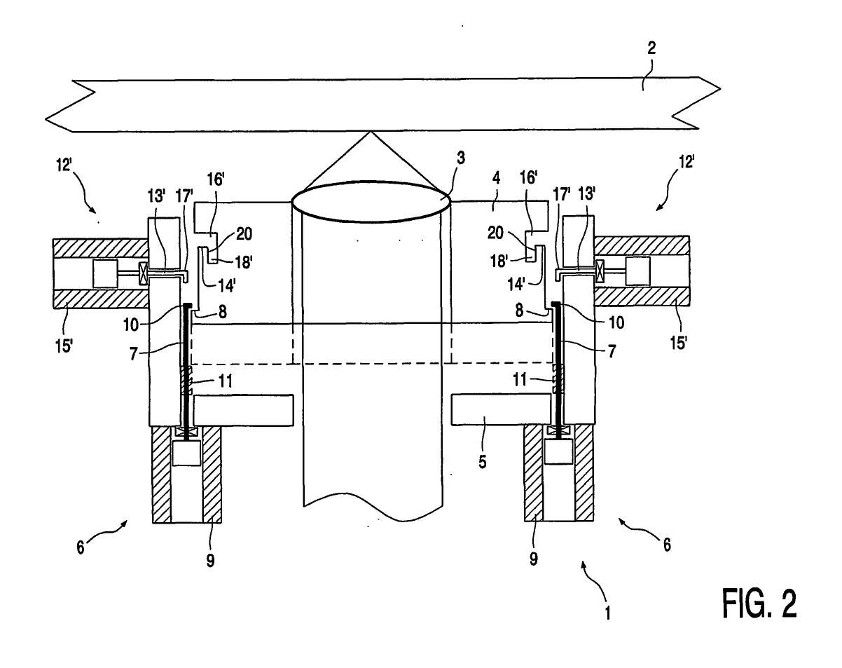

With reference to FIG. 2, the second embodiment of the pickup unit is provided with a locking arrangement 12′ comprising two first locking members 13′ having an elongated shape, for example wire members, two second locking members 14′ each in the form of a locking surface on the lens holder 4, and two linear motors as locking actuators 15′. The first and second locking members 13′, 14′ and the locking actuators 15′ are positioned on opposite sides of the lens holder 4. The first locking members 13′ are movable through the base 5 in a direction substantially perpendicular to the focusing direction of the lens 3. Each first locking member 13′ is connected to one of the two locking actuators 15′, and the locking actuators 15′ are mounted to the base 5. In this manner the locking actuators 15 are adapted to move the first locking members 13′ when they are provided with an activating signal in the form of an electrical current.

With reference to FIG. 2, the locking surfaces forming the second locking members 14′ are formed by recesses 16′ in the lens holder 4, the locking surfaces extending at least partly in a direction substantially parallel to the focusing direction of the lens 3. Each first locking member 13′ and each locking surface forming the second locking member 14′ is positioned such that they are in engagement with each other when the first locking members 13′ have been moved into the lens holder 4 and the lens holder 4 is in its inoperative position as indicated with the dashed lines in the drawing. As shown in FIG. 2, the first locking members 13′ are each provided with an L-shaped hook section 17′ at one end, such that the hook section 17′ of each locking member 13′ is facing the lens holder 4. Each of the recesses 16′ in the lens holder 4 forming the locking surfaces is further provided with a securing section 18′ forming an axially extending securing surface 20 inside the recess 16′. The securing surfaces 20 are adapted to coincide with the hook sections 17′ of the first locking members 13′ when they are in engagement with the recesses 16′, so that the hook sections 17′ and the securing sections 17′ form securing members adapted to secure the engagement of the first and second locking members 13′, 14′. In this manner the locking actuators 15′ only need to be powered when the first locking members 13′ are to be engaged with or disengaged from the second locking members 14′.

In order to control the pickup unit, a disk drive unit provided with the pickup unit 1 according to the invention comprises a control circuit which is connected to the focusing actuator and the actuators 9, 15, 15′ of the pullback arrangement 6 and the locking arrangement 12, 12′. The control circuit has at least two functions. Firstly, it is arranged to provide an activating signal to the pullback actuators 9 when a pullback condition is detected during reading and/or writing of the disk 2, and secondly, it is arranged to provide activating signals to the focusing actuator and/or the pullback actuators 9 and to the locking actuators 15, 15′ to lock the lens holder 4 when no data is read and/or written on the disk 2.

According to the first function of the control unit, the control unit includes a shock sensor which is adapted to provide a signal to the control circuit when it is exposed to strong external mechanical forces or pulses. As an alternative, the control unit is adapted to monitor the reading from and/or writing to the disk 2. A pullback condition may then be derived from disturbances during the reading and/or writing of the disk 2, for example due to an unexpected movement of the lens 3 towards or away from the disk 2 detected by the reading and/or writing member, or due to an unexpected jump between one or more data tracks on the disk 2. In this manner, collisions between the lens(holder) 3, 4 and the disk 2 are avoided, since the lens holder 4 is pulled into its inoperative position, wherein the pullback actuators 9 may remain activated as long as the pullback condition is present.

According the second function of the control unit, the control unit is adapted to determine the need for a read and/or write sequence to be performed by the disk drive unit. In other words, it is adapted to determine the conditions under which the lens holder 4 needs to be locked, for example between read and/or write bursts while the disk 2 is rotating, when the read and/or writing member is switched off, when the disk drive motor is switched off, or when the complete disk drive unit is switched off. When the lens holder 4 needs to be locked, a locking sequence is executed by the control unit, wherein an activating signal is provided to the focusing actuator or to the pullback actuators 9 in order to move the lens holder 4 slightly beyond its inoperative position, and wherein subsequently an activating signal is provided to the locking actuators 15, 15′ in order to insert the first locking members 13, 13′ into the respective recesses 16, 16′. Subsequently the focusing actuator or the pullback actuators 9 may be deactivated so that the first locking members 13, 13′ come into engagement with the respective locking surfaces forming the second locking members 14, 14′, as the suspension tries to move the lens holder 4 back to its steady position. Finally the locking actuators 15, 15′ are deactivated, while the lens holder 4 remains locked in its inoperative position owing to the engagement of the first locking members 13, 13′ and the engagement surfaces forming the second locking members 14, 14′. During the first step of the locking sequence, the lens holder 4 is moved slightly beyond the inoperative position in order to allow the hook sections 17, 17′ at the first locking members 13, 13′ to pass the locking surfaces forming the second locking members 14, 14′. When the lens holder needs to be unlocked, the above-described sequence is executed in reverse order, the reverse sequence differing between the first and the second embodiment of the pickup unit 1 in that the linear motors 15′ of the second preferred embodiment only need to be provided with an activating signal for withdrawing the first locking members 13′ towards the base.

The two function of the control unit may advantageously be combined, for example in order to lock the lens holder 4 in its inoperative position when the exposure to strong external mechanical forces or pulses exceeds a preset duration of time.

From the foregoing description it should be understood that the pickup unit 1 according to the invention comprises a pullback arrangement 9 and/or a locking arrangement 12, 12′ adapted to prevent collisions between the lens(holder) 3, 4 and the disk 2 when the pickup unit 1 is exposed to external mechanical forces or pulses, while the mass and therefore the dynamical properties of the suspended lens holder 4 are hardly affected by the presence of the pullback arrangement 6 and/or the locking arrangement 12, 12′, since the second pullback members 8 and the second locking members 14, 14′ are formed by means of recesses 16, 16′ or slots in the lens holder 4.

The invention is not restricted to the above-described embodiment as shown in the drawings, which can be varied in several ways without departing from the scope of the invention.

In general it is noted that, in this application, the expression “comprising” does not exclude other elements, and “a” or “an” does not exclude a plurality. A single processor or unit may fulfil the functions of several elements in the appended claims. Reference signs in the claims shall not be construed as limiting the scope thereof.

1. Pickup unit (1) for reading and/or writing data on a disk, comprising a lens (3) in a lens holder (4), a base (5), a suspension for suspending the lens holder (4) from the base (5), which suspension enables the lens holder (4) to be moved with respect to the base (5) at least in a focusing direction of the lens (3) under the action of a focusing actuator acting between the lens holder (4) and the base (5), and a pullback arrangement (9) for moving the lens holder (4) into an inoperative position at least during reading and/or writing of data on the disk (2), wherein the pullback arrangement (6) comprises at least a first pullback member (7) provided on the base (5), at least a second pullback member (8) formed on the lens holder (4), and a pullback actuator (9) adapted to act on the first pullback member (7) to bring it into contact with the second pullback member (8) and to move the lens holder (4) into the inoperative position.

2. Pickup unit (1) according to claim 1, wherein the second pullback member (8) is an engagement surface formed on the lens holder (4) in a direction substantially perpendicular to the focusing direction of the lens (3), wherein the first pullback member (7) is an elongated member having a hook section (10) at one end, and wherein the first pullback member (7) is movable through the base (5) in a direction substantially parallel to the focusing direction of the lens (3) such that the hook section (10) is able to engage the engagement surface forming the second pullback member (8) and to move the lens holder (4) into the inoperative position.

3. Pickup unit according to claim 1, comprising a return member (11) adapted to act on the first pullback member (7) in order to keep it out of contact with the second pullback member (8) when the pullback actuator (9) is deactivated.

4. Pickup unit (1) according to claim 1, wherein the pullback actuator (9) is a solenoid which is mounted to the base (5) and which is operatively connected to the pullback member (7).

5. Pickup unit (1) according to claim 1, further comprising a locking arrangement (12, 12′) for locking the lens holder (4) with respect to the base (5) in at least the inoperative position of the lens holder (4), wherein the locking arrangement (12, 12′) comprises at least a first locking member (13, 13′) movably connected to the base (5) and movable in a direction substantially parallel to the focusing direction, at least a second locking member (14, 14′) formed on the lens holder (4), and a locking actuator (15, 15′) adapted to act on the first locking member (13, 13′) so as to bring the first locking member (13, 13′) into engagement with the second locking member (14, 14′).

6. Pickup unit (1) according to claim 5, wherein the second locking member (14, 14′) is a locking surface formed on the lens holder (4) at least partly in a direction substantially perpendicular to the focusing direction of the lens (3), and wherein the first locking member (13, 13′) is an elongated member which is movable through the base (5) in a direction substantially perpendicular to the focusing direction of the lens (3) such that the first locking member (13, 13′) is able to engage the locking surface forming the second locking member (14, 14′) and to lock the lens holder (4) in it its inoperative position.

7. Pickup unit (1) according to claim 5, wherein the locking arrangement (12, 12′) is provided with securing members (17, 17′, 18, 18′) adapted to secure the engagement of the first and second locking member (13, 13′, 14, 14′).

8. Pickup unit (1) according to claim 5, wherein the locking actuator (15, 15′) is a solenoid or a linear motor which is mounted to the base (5) and which is operatively connected to the first locking member (13, 13′).

9. Pickup unit (1) for reading and/or writing data on a disk (2), comprising a lens (3) in a lens holder (4), a base (5), a suspension for suspending the lens holder (4) from the base (5), which suspension enables the lens holder (4) to be moved with respect to the base (5) at least in a focusing direction of the lens (3) under the action of a focusing actuator acting between the lens holder (4) and the base (5), and a locking arrangement (12, 12′) for locking the lens holder (4) with respect to the base (5) in at least an inoperative position of the lens holder (4), wherein the locking arrangement (12, 12′) comprises at least a first locking member (13, 13′) connected to the base (5) and movable in a direction substantially perpendicular to the focusing direction, at least a second locking member (14, 14′) formed on the lens holder (4), and a locking actuator (15, 15′) adapted to act on the first locking member (13, 13′) so as to move the first locking member (13, 13′) into engagement with the second locking member (14, 14′).

10. Pickup unit (1) according to claim 9, wherein the second locking member (14, 14′) is a locking surface formed on the lens holder (4) at least partly in a direction substantially perpendicular to the focusing direction of the lens (3), and wherein the first locking member (13, 13′) is an elongated member which is movable through the base (5) in a direction substantially perpendicular to the focusing direction of the lens (3) such that the first locking member (13, 13′) is able to engage the locking surface forming the second locking member (14, 14′) and to lock the lens holder (4) in it its inoperative position.

11. Pickup unit (1) according to claim 9, wherein the locking arrangement (12, 12′) is provided with securing members (17, 17′, 18, 18′) adapted to secure the engagement of the first and second locking member (13, 13′, 14, 14′).

12. Pickup unit (1) according to claim 9, wherein the locking actuator (15, 15′) is a solenoid or a linear motor which is mounted to the base (5) and which is operatively connected to the first locking member (13, 13′).

13. Pickup unit (1) according to claim 9, further comprising a pullback arrangement (6) for moving the lens holder (4) into an inoperative position at least during reading and/or writing of data on the disk (2), wherein the pullback arrangement (6) comprises at least a first pullback member (7) formed on the base (5), at least a second pullback member (8) provided on the lens holder (4), and a pullback actuator (9) adapted to act on the first pullback member (7) to bring it into contact with the second pullback member (8) and to move the lens holder (4) into the inoperative position.

14. Pickup unit (1) according to claim 13, wherein the second pullback member (8) is an engagement surface formed on the lens holder (4) in a direction substantially perpendicular to the focusing direction of the lens (3), wherein the first pullback member (7) is an elongated member having a hook section(10) at one end, and wherein the first pullback member (7) is movable through the base (5) in a direction substantially parallel to the focusing direction of the lens (3) such that the hook section (10) is able to engage the engagement surface forming the second pullback member (8) and to move the lens holder (4) into the inoperative position.

15. Pickup unit according to claim 13, comprising a return element adapted to act on the first pullback member in order to keep it out of contact with the second pullback member when the pullback actuator is deactivated.

16. Pickup unit (1) according to claim 13, wherein the pullback actuator (9) is a solenoid which is mounted to the base (5) and which is operatively connected to the first pullback member (7).

17. Disk drive unit provided with a pickup unit (1) according to claim 1, further comprising a control circuit connected to the pullback actuator (9) and including a sensor adapted to detect a pullback condition, e.g. a shock, either by directly detecting said shock or by detecting a disturbance in the reading and/or writing of the data on the disk (2) as a result of the shock, whereupon the control circuit provides an activating signal to the pullback actuator (9).

18. Disk drive unit provided with a pickup unit (1) according to claim 1, further comprising a control circuit connected to the locking actuator (15, 15′) and to the focusing actuator and/or the pullback actuator (9), wherein the control circuit is adapted to provide an activating signal to the focusing actuator or the pullback actuator (9) to move the lens holder (4) into or beyond the inoperative position and to provide an activating signal to the locking actuator (15, 15′) to move the first locking member (13, 13′) towards the lens holder (4) to come into engagement with the second locking member (14, 14′).

19. Disk drive (1) according to claim 18, wherein the control circuit is adapted to provide an activating signal to the locking actuator (15, 15′) to move the first locking member(13, 13′) out of engagement with the second locking member (14, 14′).
